(19) United States
(12) Patent Application Publication
(10) Pub. No.: US 2014/0210692 A1
(43) Pub. Date: Jul. 31, 2014

(54) SYSTEM FOR REMOTE MANAGEMENT OF ELECTRONIC SHELF DISPLAY MODULES

(71) Applicant: Opticon, Inc., Renton, WA (US)

(72) Inventors: Michael J. Waters, Tukwila, WA (US); Scott McGhee, Seattle, WA (US); Kenneth Y. Ogami, Kirkland, WA (US); Jiang Qin, Renton, WA (US)

(73) Assignee: Opticon, Inc., Renton, WA (US)

(21) Appl. No.: 13/750,019

(22) Filed: Jan. 25, 2013

(51) Int. Cl. G06Q 10/08; G06F 3/147

(52) U.S. Cl. CPC G06Q 10/087; G06F 3/147
USPC 345/2.3

(57) ABSTRACT

An electronic display system for use, for example, in a retail outlet comprises a plurality of small display module commonly known as electronic shelf labels. The system also comprises a plurality of base stations for transmitting, to the display modules, representations of images to be displayed. This disclosure teaches an electronic display system wherein base stations are connected directly to the Internet. A single processor can transmit data, metadata and commands to base stations located in different retail outlets. Thus, a single processor can remotely manage display modules in a plurality of different retail outlets that are located at different geographical locations.

### FIELD OF THE INVENTION

The present invention relates to management of electronic displays in retail stores in general, and, more particularly, to the electronic management of, and communication with electronic shelf labels used for displaying prices of goods and other goods-related information.

### BACKGROUND OF THE INVENTION

Large retail stores often deal with several tens of thousands of different kinds of goods. In such stores, much attention is paid to the management and control of the inventory of goods and the displaying and labeling of the prices of the goods being sold. Accordingly, much effort is expended and careful attention is paid to managing and controlling the stock of goods in the warehouse and to the labeling of the prices of goods displayed on shelves or showcases. Mistakes as to the labeling of the prices of goods could cause dissatisfaction to customers and damage the reputation of the store.

In the past, in a retail store, the prices of goods have been traditionally displayed by means of paper labels affixed to the edge of shelves where the goods are placed. More recently, electronic display systems have been used in order to avoid mistakes. With such electronic display systems, the traditional paper labels are replaced by electronic display modules of size and shape similar to the old paper labels. In a typical store, there may be thousands, if not tens of thousands, of such display modules, which are known as “electronic shelf labels” to reflect the fact that they are frequently affixed to the edges of shelves, just like the paper labels that they replace.

FIG. 1 depicts a typical use of electronic shelf labels. A fixture with shelves that is used in a retail store to present goods to customers is commonly known as a “gondola”. Accordingly, FIG. 1 shows gondola 115 with three shelves 116-1, 116-2, and 116-3. Goods that would normally be found on the shelves are not shown, but FIG. 1 shows electronic shelf labels 20 affixed to the edges of the shelves. Each electronic shelf labels 20 is equipped with electronic display 24, pushbutton 26, and antenna 22. Pushbutton 26 is provided in some applications of electronic shelf labels, for example, in order to enable a customer to access additional information by depressing the pushbutton. Antenna 22 is provided in order to enable electronic shelf label 20 to receive information via a wireless link.

In a simple implementation, electronic display 24 might be able to display only images of numbers; for example, electronic display 24 might consist of one or more of the well-known seven-segment patterns for displaying one or more digits. In such implementations, electronic shelf label 20 might be used to display only numerical information such as price or weight of the associated goods. In more advanced implementations, electronic display 24 might be able to display more complex images, such as alphabetical characters, or pre-defined patterns or icons that have been placed on the display at the time of manufacture. For example, liquid-crystal displays can be made with pre-determined images that are placed on the display at the time of manufacture, and that can be turned on or off electronically. In even more advanced implementations, electronic display 24 might be a dot-mapped display capable of displaying arbitrary patterns of pixels in black and white or even in color.

In all such implementations, electronic display 24 comprises a plurality of display elements on a display surface. Such a surface is, most commonly, flat, but flexible and curved displays are also becoming available. Display elements can be, for example, segments, dots, lines, or more complex patterns or images. In all cases, display elements can be turned on or off electronically, or, in more advanced electronic displays, they can be electronically controlled to have states that are intermediate between fully “on” and fully “off”. Such intermediate states can be used, for example, for displaying gray levels. Display elements might be light sources, in which case the “off” state might correspond to no light being emitted, the “on” state might correspond to maximum light being emitted, and intermediate states might correspond to intermediate amounts of light being emitted. Alternatively, display elements might be made to be transparent or opaque, with, for example, the “off” state corresponding to an opaque element, the “on” state corresponding to a transparent element, and intermediate states corresponding to an element with partial transparency. Color might be achieved through elements that are sources of colored light, or through elements that can be transparent or opaque and are backed by a source of colored light. Display elements in so-called electronic paper use electrophoretic ink and can vary their reflectivity. In some cases, they can do so in a direction-dependent way.

In general, for electronic display 24 to display an image, its display elements are electronically controlled to exhibit particular states such as “on” or “off” or intermediate states. The human perception of a particular image being present on the display derives from a particular pattern of states of display elements. Accordingly, if it is desired that a particular electronic shelf label display a particular image—for example a price of an item—it is necessary to convey to that shelf label a particular pattern of states of display elements to be implemented. This is accomplished through wireless links 170.

FIG. 1 depicts wireless communication links 170 as a particular implementation of the digital communication links that exist, in some form or another, in all electronic display systems with electronic shelf labels. Wireless links 170 originate from base station 160 which is equipped with antenna 165 for transmitting wireless digital signals. Wireless links 170 terminate in antennas 22 which receive the wireless digital signals. Wireless links are but one of many possible implementations known in the art for the digital communication links that are used for communicating with electronic shelf labels 20. Other implementations might be based, for example and without limitation, on infrared or other types of optical signals, on magnetic induction, on ultrasounds, or on other signaling methods.

In FIG. 1, wireless links 170 are used for conveying, to electronic shelf labels 20, the patterns of states of display elements to be implemented. In general, each electronic shelf label receives a different pattern of states of display elements to be implemented; however, it is also possible that the same pattern might be sent to multiple electronic shelf labels. Hereinafter, a pattern of states of display elements to be implemented by an electronic shelf label will be referred to as an “image representation”. Image representations are modulated onto the wireless digital signals carried by wireless links 170 in well-known fashion.

An important advantage of electronic display systems is the elimination of human errors that commonly occur when transcribing the prices of goods, or other information about the goods, to the paper price labels that have been used traditionally. This is accomplished by generating image representations for the electronic shelf labels in a processor that has access to the official price database.

FIG. 2 depicts a block diagram that illustrates how image representations are generated and conveyed to electronic price labels in a typical implementation of an electronic display system. Hereinafter, the term “retail outlet” will be used, instead of the more colloquial term “retail store”, to refer to an establishment where an electronic display system is used. Retail outlet 210, depicted as a dashed rectangular outline, might be, for example, a grocery store with multiple aisles and thousands of different types of goods offered for sale.

At retail outlet 210, the manager of the retail outlet, depicted in FIG. 2 as store manager 220, enters, into a computer, data relative to the goods being offered for sale at retail outlet 210 (hereinafter, data relative to goods will be referred to as “goods data”). The computer is depicted in FIG. 2 as processor 230; the goods data entered by store manager 220 into processor 230 are depicted as goods data 225. Goods data 225 might comprise, for example, a complete price database for all the goods in the store. Such price database might comprise, for example, reduced prices to be offered to customers on a particular day when the store is having a promotional sale. Before opening the store on the day of the promotional sale, it is necessary that all electronic shelf labels display the promotional sale prices.

Before opening the store on the day of the promotional sale, the store manager enters a new price database into the computer. The new price database contains discounted prices for the promotional sale. The computer, depicted by processor 230 in FIG. 2, generates image representations for all the electronic shelf labels that need to display a changed price for the promotional sale. The image representations, depicted in FIG. 2 by image representations 255-1, 255-2, and 255-3, are conveyed to a plurality of base stations. The base stations are depicted in FIG. 2 by base stations 260-1, 260-2, and 260-3. They might be, for example, installed in the ceiling of the store.

The base stations transmit wireless signals through antennas 265-1, 265-2, and 265-3. The wireless signals travel over wireless links 270 and are received by a plurality of electronic shelf labels which are depicted in FIG. 2 as ESL 280-1 through ESL 280-6. Electronic shelf labels 280-1 through 280-6 receive wireless signals through antennas 275-1 through 275-6, respectively. The antennas are where wireless links 270 terminate. Wireless links 270 are depicted in FIG. 2 as dashed lines and the figure shows that multiple wireless links from multiple base stations might terminate at the same electronic shelf label. Such an arrangement provides multiple paths for image representations to reach electronic shelf labels. Such redundancy provides enhanced reliability.

There are several advantages in using an electronic display system with electronic shelf labels, compared to using traditional paper labels. Some of the advantages are: 1) errors are reduced because image representations for the images to be displayed by the electronic shelf labels are generated by processor 230, which has the full price database; 2) store manager 220 can, without assistance from others, change the prices displayed by electronic shelf labels simply by entering changed goods data 225 into processor 230; 3) more information can be displayed by electronic shelf labels, compared to paper labels. Because of these and other advantages, electronic display systems are becoming more and more widespread.

Despite the advantages mentioned in the previous paragraphs, current electronic display systems still have some disadvantages. In particular, human intervention is required at retail outlet 210, represented by store manager 230, in order to effect changes in the information displayed by the electronic shelf labels. Also, each retail outlet in a large chain comprising multiple retail outlets is required to have processor 230. This might make electronic display systems expensive, especially for smaller retail outlets.

### SUMMARY OF THE INVENTION

Embodiments of the present invention provide electronic display systems without some of the disadvantages of prior-art electronic display systems. In particular, new image representations can be conveyed to electronic shelf labels without requiring human intervention at each retail outlet, and the cost of having processor 230 at each retail outlet is eliminated.

Hereinafter, the term “display module” will be used, instead of the more colloquial term “shelf label”, to reflect the fact that, in general, such a device might not be necessarily affixed to an edge of a shelf. In many applications, electronic display modules might be affixed to or placed near a variety of objects, other than shelves, where a programmable display of information might be desired. Also, although the description of embodiments of the present invention will make reference to retail outlets, it will be clear to those skilled in the art, after reading this disclosure, how to make and use electronic display systems in accordance with the present invention for use in establishments other than retail outlets. For example, and without limitation, such systems might be used in warehouses to assist with inventory maintenance, or in other situations where display of information associated with goods or other items might be desired.

Electronic display systems in accordance with some embodiments of the present invention comprise a plurality of base stations and a plurality of display modules at a plurality of retail outlets. In such embodiments, the base stations have a receiver that enables them to receive data directly over the Internet. Furthermore, the base stations also have the capability of generating image representations from goods data. Because the base stations have such capability, the retail outlets do not need to have processor 230, as was the case in the prior art. Instead, the base stations are directly connected to the Internet. Through the Internet, base stations in different retail outlets receive data from the same processor. That processor might be, for example, located in a centralized location where it has access to goods data about the goods being offered for sale at the retail outlets.

Through the Internet, the processor conveys goods data to the base stations. For example, the processor might convey, to each base station, only the goods data that the base station needs. At each base station, the base station generates image representations based on the goods data, and transmits such image representations to a plurality of display modules. For example, such transmission might occur through wireless links.

### BRIEF DESCRIPTION OF THE DRAWINGS

FIG. 1 depicts a gondola with display shelves and electronic shelf labels on the edges of shelves in the prior art.

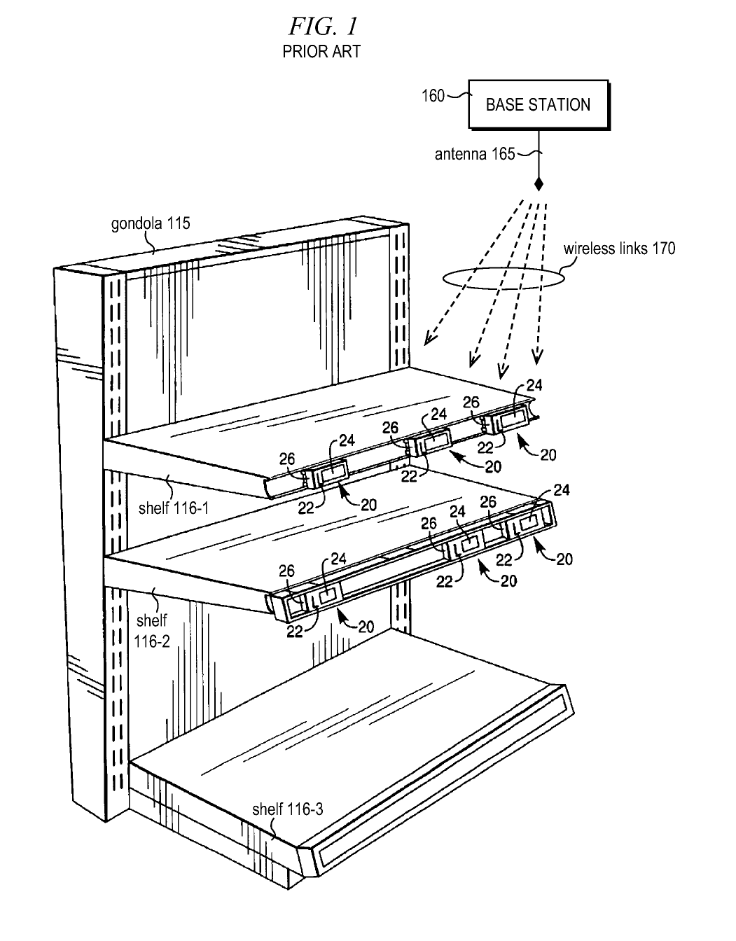

FIG. 2 depicts a system for local management of electronic shelf labels in the prior art.

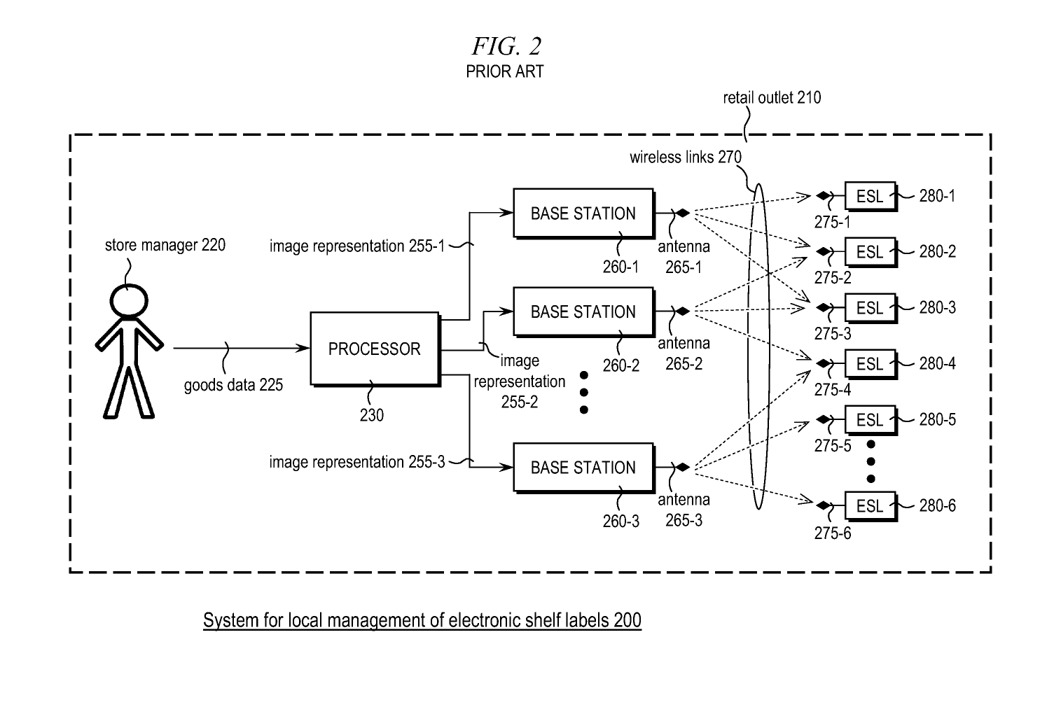

FIG. 3 depicts a system for local management of electronic shelf-display modules in the prior art.

FIG. 4 depicts a block diagram of a base station in accordance with some embodiments of the present invention.

### DETAILED DESCRIPTION

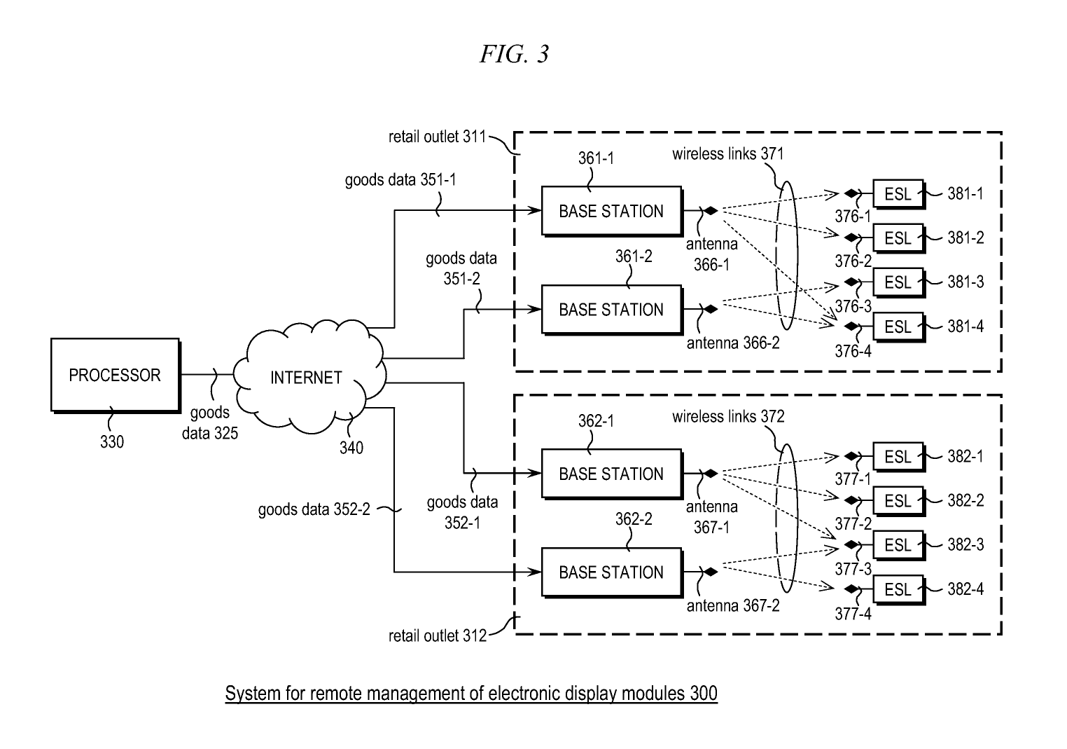

FIG. 3 depicts a block diagram of a system for remote management of electronic display modules 300 in accordance with an illustrative embodiment of the present invention. The system comprises: processor 330, for generating goods data 325 and for transmitting such goods data through the Internet. The Internet is depicted in FIG. 3 as Internet 340.

The system also comprises base stations 361-1 and 362-2 located at retail outlet 311, and base stations 362-1 and 362-2 located at retail outlet 312. The base stations receive, over the Internet, goods data that were transmitted by processor 330. Such goods data are depicted in FIG. 3 as goods data 351-1 and 351-2, which are received by base stations located at retail outlet 311, and goods data 352-1 and 352-2, which are received by base stations located at retail outlet 312.

The system also comprises electronic display modules 381-1 through 381-4, and 382-1 through 382-4. Such display modules receive wireless signals over wireless links 371, and 372, respectively, as depicted in FIG. 3, over antennas 376-1 through 376-4, and 377-1 through 377-4, respectively, as depicted. The wireless signals carry image representations for images to be displayed on the display modules.

The wireless signals are transmitted over wireless links 371 and 372 by base stations 361-1 and 361-2, and 362-1 and 362-2, respectively, as depicted in FIG. 3, through antennas 366-1 and 366-2, and 367-1 and 367-2, respectively, as depicted. Wireless signals transmitted by base stations at one retail outlet are not received by display modules at a different retail outlet, and vice versa.

In some embodiments of the present invention, goods data received by one base station might be the same as goods data received by other base station. In other embodiments, goods data received by one base station might be different from goods data received by some other base station. For example, and without limitation, processor 330 might customize goods data sent to base stations at a particular retail outlet to reflect the particular display needs of that particular outlet; alternatively, for example and without limitation, processor 330 might customize goods data sent to a particular base stations to only contain data relevant to the display modules that can receive signals from that base station.

In the illustrative embodiment of the present invention depicted in FIG. 3, the base stations are shown as receiving goods data through the Internet. However, it will be clear to those skilled in the art, after reading this disclosure, how to make and use embodiments of the present invention wherein the base stations receive other types of data. For example, and without limitation, the base stations might receive metadata or commands through the Internet. Such metadata or commands might be generated by processor 330, or they might be generated, for example and without limitation, by other processors or other devices connected to the Internet and capable of transmitting such commands or metadata, or other types of data, through the Internet.

In the illustrative embodiment of the present invention depicted in FIG. 3, processor 330 might be, for example and without limitation, a computer. However, it will be clear to those skilled in the art, after reading this disclosure, how to make and use embodiments of the present invention wherein processor 330 is some other kind of processor. For example and without limitation, processor 330 might be a tablet, a smartphone, an internet appliance, or some other device capable of communicating through the Internet with the base stations.

In the illustrative embodiment of the present invention depicted in FIG. 3, processor 330 is shown without any explicit input from a human operator. Indeed, embodiments of the present invention are possible wherein processor 330 operates autonomously and automatically to control and manage base stations 361-1, and 361-2, and 362-1 and 362-2 by sending them goods data, metadata and commands. However, it will be clear to those skilled in the art, after reading this disclosure, how to make and use embodiments of the present invention wherein a human operator interacts with processor 330. For example, and without limitation, a human operator might direct processor 330 to send certain data, metadata, or commands to the base station as selected by the human operator; or the human operator might upload a new price database or other information to be displayed on some or all of the display modules either immediately or at specifically-selected future time. Such human interaction with processor 330 might occur, for example and without limitation, through a web browser that implements a graphical user interface (GUI) specified, for example and without limitation, by an HTML file residing on processor 330. Alternatively, the human operator might, for example and without limitation, interact directly with base station. In such a case, the operator might, for example, use a web browser that runs on processor 330 to communicate and interact with a base station that specifies a graphical user interface by means of an HTML file residing on the base station itself.

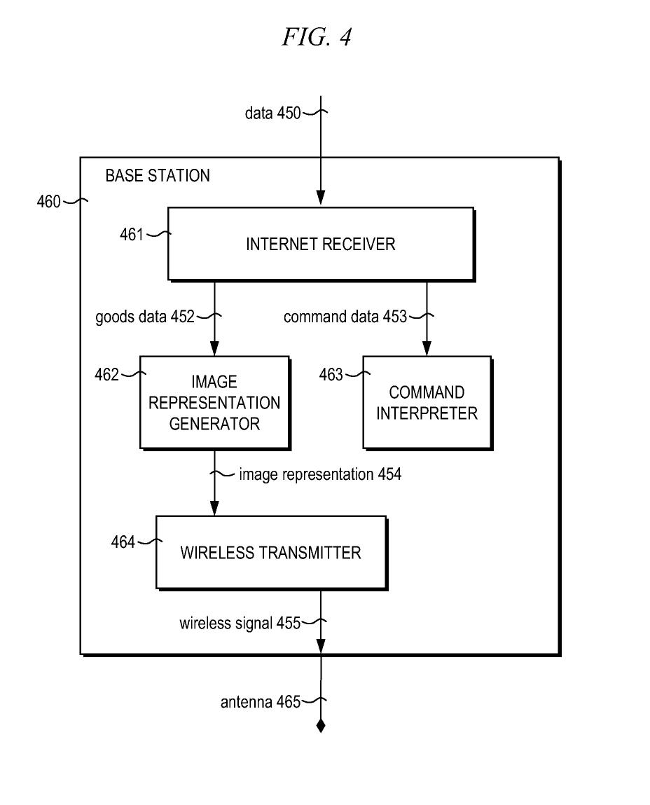

FIG. 4 depicts a block diagram of a base station in accordance with some embodiments of the present invention. Base station 460 comprises: internet receiver 461, image representation generator 462, command interpreter 463, wireless transmitter 464, and antenna 465, interrelated as shown.

Base station 460 receives data 450 through internet receiver 461. Data 450 comprises goods data 452 and command data 453. Command data 453 is interpreted by command interpreter 463, which executes commands contained in command data 453. Goods data 452 is processed by image representation generator 462 which generates image representation 454 based on goods data 452.

Wireless transmitter 464 accepts modulates image representation 454 onto wireless signal 455, and then transmits wireless signal 455 through antenna 465.

It is to be understood that the disclosure teaches just one example of the illustrative embodiment and that many variations of the invention can easily be devised by those skilled in the art after reading this disclosure and that the scope of the present invention is to be determined by the following claims.

### Markman Definitions

Base Station—For the purposes of this specification, a “base station” is defined as a device for communicating with a plurality of display modules. Frequently, but not always, such communication is through wireless links. The term “access point” is sometimes used in the art to refer to a base station as defined here; however, in this specification, such a term is not used as a synonym of “base station” so as to avoid confusion with the use of the term “access point” referred to a WiFi-enabled or Bluetooth-enabled access point that is used as a network entity. Also, it is noted that the term “base station” is frequently used in the art to refer to cellular base stations that support wireless communications for mobile communication terminals such as cellphones. For the purposes of this specification, the term “base station” should be understood to be limited to the definition provided above.

Based on—For the purposes of this specification, the phrase “based on” is defined as “being dependent on” in contrast to “being independent of”. Being “based on” includes both functions and relations.

Command—For the purposes of this specification, a “command” is defined as a directive to a base station to perform a specific action or task.

Command Interpreter—For the purposes of this specification, a “command interpreter” is defined as hardware or hardware and software that can execute commands.

Data Structure—For the purposes of this specification, “data structure” is defined as a collection of data organized so as to facilitate the use of the data and the interpretation of their meaning. For example, and without limitation, digital data that represent an image are most useful when organized as a data structure wherein the mapping between data bits and image elements such as, for example, pixels is well defined and easy to implement.

Display—For the purposes of this specification, a “display” is defined as hardware or hardware and software that converts an image representation into an image that is visible to a human eye. A display comprises display elements arranged on a display surface that can be flat or curved. The display described in the illustrative embodiment might have more limitations than a display in the claims.

Display Element—For the purposes of this specification, a “display element” is defined as a portion of the surface of a display whose visible characteristics can be controlled electronically. Such visible characteristics comprise, but are not limited to, one or more of the following: (i) brightness, (ii) color, (iii) radiance, (iv) irradiance, (v) transparency, (vi) reflectivity, (vii) reflectance, (viii) polarization. A display element can have any shape, including, but not limited to, a circle, a square, a rectangle, or a silhouette with a shape recognizable by a human viewer. The “state” of a display element at a particular time is the particular value or values, at that particular time, of its visible characteristic or characteristics that can be controlled electronically.

To Exhibit—For the purposes of this specification, the infinitive “to exhibit” and its inflected forms (e.g., “exhibiting”, “exhibits”, etc.) is defined as “to manifest or make evident.”

To Generate—For the purposes of this specification, the infinitive “to generate” and its inflected forms (e.g., “generating”, “generation”, etc.) should be given the ordinary and customary meaning that the terms would have to a person of ordinary skill in the art at the time of the invention.

Geographical location—For the purposes of this specification, a “geographical location” is defined as a place on the earth. For the purposes of this specification, different geographical locations are places that most people would regard as different places; in particular, places that are at least 2 km away from one another should be considered different places.

Gondola—For the purposes of this specification, a “gondola” is defined as a fixture used by retailers to display goods. A gondola typically comprises a flat base and a vertical component featuring notches, pegboards, or slatwalls. The vertical piece can be fitted with shelves, hooks, or other supporting structures for holding goods.

HTML—For the purposes of this specification, “HTML” is an acronym that stands for “HyperText Markup Language”. HTML is the main markup language for displaying web pages and for specifying graphical user interfaces that can be implemented by a web browser. There are many versions of HTML, with more recent versions generally providing greater power and flexibility than earlier versions. Also, there are many variations of and successors to HTML such as, for example and without limitation, SGML, XML, and XHTML; wherein SGML stands for “Standard Generalized Markup Language”; XML stands for “Extensible Markup Language”; and XHTML stands for “Extensible HyperText Markup Language”. For the purposes of this specification, “HTML” is defined to include all of these variations and successors and all other variations and successors not explicitly mentioned here, and also other, possibly unrelated, languages, standards and protocols that, similarly to HTML, allow the implementation of a graphical user interface for communicating with and/or controlling a base station through an Internet connection.

Image—For the purposes of this specification, an “image” is defined as something that is visible to a human eye. This definition is somewhat more restrictive than common usage in connection with electronic devices wherein, for example, one might refer to “an image stored in memory”. In reality, what is stored in memory in such cases is a pattern of bits that becomes an actual visible image only when processed by a display. For the purposes of this specification, such a pattern of bits falls within the definition of an “image representation”, whose definition is provided below.

Image Representation—For the purposes of this specification, an “image representation” is defined as a data structure that defines a pattern of states of display elements for implementation by a particular display. An image representation becomes an actual visible image when implemented by a display.

Internet—For the purposes of this specification, “Internet” is a proper noun; it is written with an initial capital letter, and is defined as the global system of interconnected computer networks that use the standard Internet protocol suite known as TCP/IP to serve billions of users worldwide. In the Internet, data travel from point to point in the form of packets. Several types of entities in the Internet facilitate the transfer of data from source to destination. Such entities are known by names such as “hub”, “switch”, “bridge”, “router”, “gateway”, and “firewall”, to name just a few. These names reflect the functionality of those entities. Such functionalities can be complex and very advanced; however, in all cases, the purpose is to convey data across the network without altering the data themselves. In other words, the purpose of such functionalities is data communication, as opposed to data processing. For example, and without limitation, functionalities such as network address translation (NAT), filtering, encapsulation, de-encapsulation, routing, switching, and tunneling, to name just a few, are aimed at achieving efficient and faithful delivery of data, from one place to another in the Internet, without processing the data payload in any form or way.

In accordance with the definition of “Internet” provided in the previous paragraph, for the purposes of this specification, network entities that provide only communication functionalities, such as the entities mentioned in the previous paragraph, should be considered to be part of the Internet. For example, in a typical Small Office/Home Office (SOHO) environment, there might be a connection to the Internet provided by an Internet Service Provider (ISP) and there might be one or more network entities on the SOHO premises to enable multiple computers or printers or other such devices to connect to the internet. Such entities might be referred to as “routers”, “residential gateways” etc. In many cases, they might also provide wireless networking in accordance with protocols known as WiFi or Bluetooth. Entities that provide such wireless networking are sometimes known as “Access Points”. All such devices fall within the definition provided above for entities that provide a communication functionality without data processing.

Based on the definitions provided in the previous two paragraphs, for the purposes of this specification, a base station should be considered to be directly connected to the Internet even if it is connected to the Internet through any combination of entities that provide only a communication functionality. Such entities might comprise routers, switches, residential gateways, wireless access points, etc. The connection to the Internet should be considered a direct connection even if such entities are privately owned or are physically located at the same geographical location as the base station.

Metadata—For the purposes of this specification, “metadata” is defined as data providing information about one or more aspects of other data. For example and without limitation, in the context of the present invention, metadata might provide information on the format of an image or on where, when, and how such an image should be displayed.

Processor—For the purposes of this specification, a “processor” is defined as hardware or hardware and software that performs mathematical and/or logical operations. The processor described in the illustrative embodiment might have more limitations than a processor in the claims.

To Receive—For the purposes of this specification, the infinitive “to receive” and its inflected forms (e.g., “receiving”, “received”, “reception”, etc.) should be given the ordinary and customary meaning that the terms would have to a person of ordinary skill in the art at the time of the invention. In this specification, the preposition “over” is used to indicate reception from a supporting medium or channel, as in “receiving over a network. In contrast, the preposition “through” is used to indicate transmission by means of a supporting medium or channel, as in “transmitting through a network”. The reason for using different prepositions is to enhance clarity.

As mentioned in the definition of “Internet”, a base station should be considered to be directly connected to the Internet even if it is connected to the Internet through a combination of entities as described in the definition of “Internet”. Accordingly, for the purposes of this specification, phrases such as “reception over the Internet” should be understood to include reception over such entities that might not be considered part of the Internet in common word usage, but are defined to be part of the Internet in the definition of “Internet” for the purposes of this specification.

State of a Display Element—See the definition of “Display Element”.

To Transmit—For the purposes of this specification, the infinitive “to transmit” and its inflected forms (e.g., “transmitting”, “transmitted”, “transmission”, etc.) should be given the ordinary and customary meaning that the terms would have to a person of ordinary skill in the art at the time of the invention. In this specification, the preposition “through” is used to indicate transmission by means of a supporting medium or channel, as in “transmitting through a network”. In contrast, the preposition “over” is used to indicate reception from a supporting medium or channel, as in “receiving over a network”. The reason for using different prepositions is to enhance clarity.

As mentioned in the definition of “Internet”, a base station should be considered to be directly connected to the Internet even if it is connected to the Internet through a combination of entities as described in the definition of “Internet”. Accordingly, for the purposes of this specification, phrases such as “transmission through the Internet” should be understood to include transmission through such entities that might not be considered part of the Internet in common word usage, but are defined to be part of the Internet in the definition of “Internet” for the purposes of this specification.

When—For the purposes of this specification, the word “when” is defined as “upon the occasion of.”

What is claimed is:

1. A method for displaying images on a plurality of display modules, the method comprising:
(i) generating, by a processor, data about goods;
(ii) transmitting, by the processor, the data through a network;
(iii) receiving, by a base station, the data over the network;
(iv) generating, by the base station, an image representation based on the data;
(v) transmitting, by the base station, the image representation to a display module;
(vi) receiving, by the display module, the image representation; and
(vii) displaying, by the display module, an image based on the image representation.

2. The method of claim 1 wherein the network is the Internet, and wherein the base station is directly connected to the Internet.

3. The method of claim 1 wherein the display module is an electronic shelf label.

4. The method of claim 1 wherein the display module is affixed to a gondola at a retail outlet.

5. The method of claim 1 further comprising:
(viii) generating, by the processor, a command for the base station;
(ix) transmitting, by the processor, the command through the network;
(x) receiving, by the base station, the command over the network; and
(xi) executing, by the base station, the command.

6. The method of claim 1 further comprising:
(viii) generating, by the processor, metadata;
(ix) transmitting, by the processor, the metadata through the network;
(x) receiving, by the base station, the metadata over the network; and
(xi) generating, by the base station, the image representation based also on the metadata.

7. The method of claim 1 wherein an end-user interacts with the processor via a browser.

8. The method of claim 1 wherein the processor is selected from the group consisting of a computer, a cellphone, a smartphone, and a tablet.

9. The method of claim 1 wherein the base station transmits the image representation to the display module through a wireless link.

10. A method for displaying images on a plurality of display modules, the method comprising:
(i) generating, by a processor, first data about first goods and second data about second goods;
(ii) transmitting, by the processor, the first data and the second data through a network;
(iii) receiving, by a first base station, the first data over the network;
(iv) receiving, by a second base station, the second data over the network;
(v) generating, by the first base station, a first image representation based on the first data;
(vi) generating, by the second base station, a second image representation based on the second data;
(vii) transmitting, by the first base station, the first image representation to a first display module;
(viii) transmitting, by the second base station, the second image representation to a second display module;
(ix) receiving, by the first display module, the first image representation;
(x) receiving, by the second display module, the second image representation;
(xi) displaying, by the first display module, a first image based on the first image representation; and,
(xii) displaying, by the second display module, a second image based on the second image representation;
wherein the first base station and the second base station are at different geographical locations.

11. The method of claim 10 wherein the network is the Internet, and wherein the first base station and the second base station are directly connected to the Internet.

12. The method of claim 10 wherein the first display module and the second display module are electronic shelf labels.

13. The method of claim 10 wherein:
the first display module is affixed to a first gondola at a first retail outlet;
the second display module is affixed to a second gondola at a second retail outlet; and
the first retail outlet and the second retail outlet are not the same retail outlet.

14. The method of claim 10 wherein an end-user interacts with the processor via a browser.

15. The method of claim 10 wherein:
the first base station transmits the first image representation to the first display module through a first wireless link;
the second base station transmits the second image representation to the second display module through a second wireless link; and
the first wireless link and the second wireless link belong to different wireless networks.

16. A base station comprising:
a receiver for receiving, over a network, data about goods, wherein the data is generated by a processor;
an image representation generator for generating an image representation based on the data; and
a transmitter for transmitting the image representation to a display module;
wherein the display module displays an image based on the image representation.

17. The base station of claim 16 wherein the network is the Internet, and wherein the receiver is for receiving data about goods over the Internet via a direct connection to the Internet.

18. The base station of claim 16 wherein
the receiver is also for receiving, over the network, a command generated by the processor;
wherein the base station further comprises a command interpreter for executing the command.

19. The base station of claim 16 wherein
the receiver is also for receiving, over the network, metadata generated by the processor;
wherein the image representation generator generates the image representation based also on the metadata.

20. The base station of claim 16 wherein the transmitter is for transmitting the image representation to a display module through a wireless link.

21. A system for managing a plurality of display modules, the system comprising:
a processor, for (a.1.i) generating first data about first goods, and for (a.1.ii) transmitting the first data through a network;
a first base station, for (b.1.i) receiving the first data over the network, for (b.1.ii) generating a first image representation based on the first data, and for (b.1.iii) transmitting the first image representation to a first display module;
wherein the first display module is for (c.1.i) receiving the first image representation, and for (c.1.ii) displaying a first image based on the first image representation.

22. The system of claim 21 wherein the network is the Internet, and wherein the first base station is for receiving the first data over the Internet via a direct connection to the Internet.

23. The system of claim 21 wherein the first display module is an electronic shelf label.

24. The system of claim 21 wherein the first display module is affixed to a gondola at a retail outlet.

25. The system of claim 21 wherein:
the processor is also for (a.1.iii) generating a first command for the first base station, and for (a.1.iv) transmitting the first command through the network; and
the first base station is also for (b.1.iv) receiving the first command over the network, and for (b.1.v) executing the first command.

26. The system of claim 21 wherein:
the processor is also for (a.1.v) generating first metadata, and for (a.1.vi) transmitting the first metadata through the network; and
the first base station is also for (b.1.vi) receiving the first metadata over the network, and for (b.1.vii) generating the first image representation based also on the first metadata.

27. The system of claim 21 wherein an end-user interacts with the processor via a browser.

28. The system of claim 21 wherein the processor is selected from the group consisting of a computer, a cellphone, a smartphone, and a tablet.

29. The system of claim 21 wherein the first base station is for transmitting the first image representation to a first display module through a wireless link.

30. The system of claim 21 further comprising the first display module.

31. The system of claim 30 wherein the network is the Internet, and wherein the first base station is for receiving the first data over the Internet via a direct connection to the Internet.

32. The system of claim 21 further comprising:
a second base station, for (b.2.i) receiving, over the network, second data about second goods, for (b.2.ii) generating a second image representation based on the second data, and for (b.2.iii) transmitting the second image representation to a second display module;
wherein the processor is also for (a.2.i) generating the second data, and for (a.2.ii) transmitting the second data through the network;
wherein the second display module is for (c.2.i) receiving the second image representation, and for (c.2.ii) displaying a second image based on the second image representation; and
wherein the first base station and the second base station are at different geographical locations.

33. The system of claim 32 wherein the network is the Internet, and wherein the first base station and the second base station are for receiving the first data and the second data, respectively, over the Internet via direct connections to the Internet.

34. The method of claim 32 wherein the first display module and the second display module are electronic shelf labels.

35. The method of claim 32 wherein the first display module is affixed to a first gondola at a first retail outlet, and the second display module is affixed to a second gondola at a second retail outlet; and
wherein the first retail outlet and the second retail outlet are not the same retail outlet.

36. The system of claim 32 further comprising the first display module and the second display module.

37. The system of claim 36 wherein the network is the Internet, and wherein the first base station and the second base station are for receiving the first data and the second data, respectively, over the Internet via direct connections to the Internet.

38. A system for managing a plurality of display modules, the system comprising:
a processor, for (a.1.i) generating first data about first goods, for (a.2.i) generating second data about second goods, for (a.1.ii) transmitting the first data through a network, and for (a.2.ii) transmitting the second data through the network;
a first base station, for (b.1.i) receiving the first data over the network, for (b.1.ii) generating a first image representation based on the first data, and for (b.1.iii) transmitting the first image representation to a first display module;
a second base station, for (b.2.i) receiving the second data over the network, for (b.2.ii) generating a second image representation based on the second data, and for (b.2.iii) transmitting the second image representation to a second display module;
wherein the first display module is for (c.1.i) receiving the first image representation, and for (c.1.ii) displaying a first image based on the first image representation;
wherein the second display module is for (c.2.i) receiving the second image representation, and for (c.2.ii) displaying a second image based on the second image representation; and
wherein the processor further comprises a table of network addresses, wherein the network addresses are for use as destination addresses for communication packets;
wherein the table of network addresses contains a first network address that corresponds to a first network node, and a second network address that corresponds to a second network node;
wherein the first network node and the second network node are at different geographical locations;
wherein the processor is also for (a.1.iii) encapsulating the first data into first packets for transmission through the network, and (a.2.iii) encapsulating the second data into second packets for transmission through the network; and
wherein the first packets comprise a first destination address that is the first network address, and the second packets comprise a second destination address that is the second network address.
